(19) United States
(12) Patent Application Publication
(10) Pub. No.: US 2025/0335157 A1
(43) Pub. Date: Oct. 30, 2025

(54) INTERMEDIATE LANGUAGE GENERATION APPARATUS, INTERMEDIATE LANGUAGE GENERATION METHOD AND NON-TRANSITORY STORAGE MEDIUM

(71) Applicant: NEC Corporation, Tokyo (JP)

(72) Inventor: Kazuhisa ISHIZAKA, Tokyo (JP)

(73) Assignee: NEC Corporation, Tokyo (JP)

(21) Appl. No.: 19/173,954

(22) Filed: Apr. 9, 2025

(30) Foreign Application Priority Data
Apr. 24, 2024 (JP) 2024-070379

(51) Int. Cl. G06F 8/30

(52) U.S. Cl. CPC G06F 8/31

(57) ABSTRACT

An intermediate language generation apparatus generates, in generating an intermediate language for processes written in the program to be executed, an intermediate language for a portion of the processes and executes the generated intermediate language for the portion; and generates, based on execution results of the intermediate language for the portion, an intermediate language for processes subsequent to the portion of processes among the processes, and generates an intermediate language corresponding to the entire program, in which the intermediate language for the subsequent processes is added to the intermediate language for the portion.

This application is based upon and claims the benefit of priority from Japanese patent application No. 2024-070379, filed Apr. 24, 2024, the disclose of which is incorporated herein in its entirety by reference.

### TECHNICAL FIELD

The present disclosure relates to an intermediate language generation apparatus, an intermediate language generation method, and a non-transitory storage medium.

### BACKGROUND ART

Patent Document 1 (Japanese Unexamined Patent Application, First Publication No. 2010-225162) discloses a method for generating intermediate language (also referred to as an intermediate representation (IR)) for computer program code. In a processing scheme wherein, when executing a program, intermediate language is generated and the generated intermediate language is executed, there are cases in which, when attempting to generate intermediate language for a series of processes, unless intermediate language is executed for a portion of the series of processes, intermediate language cannot be generated for subsequent processes or efficient intermediate language cannot be generated.

For example, there is a command (project_column command) for reading a column from a table and a command (project_table command) for reading multiple columns. Additionally, if a project_column command is issued for a table in which there are multiple columns with the same name, an error occurs. Consider a function or a method for reading data from a designated column in a designated table by designating a table and a column name from a user program. In this function, for example, if the process is written so that a project_table command is issued when there are multiple columns with the same column name in a target table, and a project_column command is issued when there is only one column with the column name, the data from the designated column can be read from the target table without causing an error, even in the case in which a table includes multiple columns with the same column name. Consider the user program for calling this function below.

(User Program 1)

tbl = read_csv(“data.csv”)
sorted = sort_table(tbl, key=“A”)
result = project(tbl, “B”)

The first line of User Program 1 means that the file data.csv is to be read, and that the read data, in the form of a table, is set as a tbl object. The second line means that the read data is sorted by column A. The third line means that column B is read from the read table. The term project(tbl, “B”) is the above-mentioned function. The intermediate language generated from User Program 1 is the following.

### (Intermediate Language of User Program 1)

%1 = read_csv(“data.csv”)
%2 = sort_table(%1, “A”)
%3 = project_column(%2, “B”)

The generated intermediate language is not immediately executed at the time of generation, and is executed at a timing at which execution is required (define-by-run scheme). Such an intermediate language execution method is also known as delayed execution. In this case, if it is assumed that there are no redundant columns in the table, since only column A and column B are of interest, intermediate language optimized to read only column A and column B can be generated as indicated below.

### (Example of Optimized Intermediate Language for User Program 1)

%1 = read_csv(“data.csv”)
%2 = project_table(%1, [“A”, “B”])
%3 = sort_table(%2, “A”)
%4 = project_column(%3, “B”)

However, since it is not known whether or not there are redundant columns in the table, the following is executed:

%1 = read_csv(“data.csv”)
%2 = sort_table(%1, “A”)

After checking whether or not column B is redundant in the read table, the following is generated in accordance with the check result.

%3 = project_column(%2, “B”)

Thus, the columns other than column A and column B are also required to be sorted, and the efficiency of User Program 1 is reduced in comparison with the “(Example of optimized intermediate language for User Program 1)”. This is an example of a situation in which, “unless the intermediate language is executed for a portion of the series of processes, intermediate language cannot be generated for subsequent processes or efficient intermediate language cannot be generated”, as mentioned above.

### SUMMARY

One objective is to provide a method for executing intermediate language for a portion of a series of processes, and based on the results thereof, also generating intermediate language for subsequent processes.

According to an example of an embodiment disclosed herein, an intermediate language generation apparatus is provided at least one memory configured to store instructions; and at least one processor configured to execute the instructions to: in generating an intermediate language for processes written in the program to be executed, generate an intermediate language for a portion of the processes and execute the generated intermediate language for the portion; and generate, based on execution results of the intermediate language for the portion, an intermediate language for processes subsequent to the portion of processes among the processes, and generate an intermediate language corresponding to the entire program, in which the intermediate language for the subsequent processes is added to the intermediate language for the portion.

According to an example of an embodiment disclosed herein, an intermediate language generation method includes, in generating an intermediate language for processes written in a program to be executed, generating an intermediate language for a portion of the processes, and executing the generated intermediate language for the portion; and generating, based on execution results of the intermediate language for the portion, an intermediate language for processes subsequent to the portion of processes among the processes, and generating an intermediate language corresponding to the entire program, in which the intermediate language for the subsequent processes is added to the intermediate language for the portion.

According to an example of an embodiment disclosed herein, a program stored in a non-transitory storage medium makes a computer execute steps of, in generating an intermediate language for processes written in a program to be executed, generating an intermediate language for a portion of the processes, and executing the generated intermediate language for the portion; and generating, based on execution results of the intermediate language for the portion, an intermediate language for processes subsequent to the portion of processes among the processes, and generating an intermediate language corresponding to the entire program, in which the intermediate language for the subsequent processes is added to the intermediate language for the portion.

### BRIEF DESCRIPTION OF THE DRAWINGS

FIG. 1 is a diagram illustrating an example of an intermediate language generation apparatus according to an example embodiment.

FIG. 2 is a diagram schematically illustrating an intermediate language generation process and execution process according to an example embodiment.

FIG. 3 is a diagram illustrating an example of a front end configuration according to an example embodiment.

FIG. 4 is a first diagram illustrating an example of a table used for intermediate language generation in an example embodiment.

FIG. 5 is a second diagram illustrating an example of a table used for intermediate language generation in an example embodiment.

FIG. 6 is a third diagram illustrating an example of a table used for intermediate language generation in an example embodiment.

FIG. 7 is a fourth diagram illustrating an example of a table used for intermediate language generation in an example embodiment.

FIG. 8 is a fifth diagram illustrating an example of a table used for intermediate language generation in an example embodiment.

FIG. 9 is a flow chart indicating an example of an intermediate language generation process according to an example embodiment.

FIG. 10 is a first diagram for explaining the effects of the intermediate language generation process according to an example embodiment.

FIG. 11 is a second diagram for explaining the effects of the intermediate language generation process according to an example embodiment.

FIG. 12 is a diagram illustrating another example of an intermediate language generation apparatus according to an example embodiment.

FIG. 13 is a flow chart indicating an example of the operations in an intermediate language generation apparatus according to an example embodiment.

FIG. 14 is a diagram illustrating an example of the hardware configuration of an intermediate language generation apparatus according to an example embodiment.

### EXAMPLE EMBODIMENTS

Hereinafter, intermediate language generation processes according to example embodiments disclosed herein will be explained with reference to the drawings. Regarding the features in portions unrelated to the present disclosure in the drawings used for the explanation below, there are cases in which descriptions of the features are omitted and the features are not illustrated in the drawings. Identical or corresponding features in all of the drawings are assigned identical reference symbols, and there are cases in which common explanations are omitted.

### Example Embodiment

### (System Configuration)

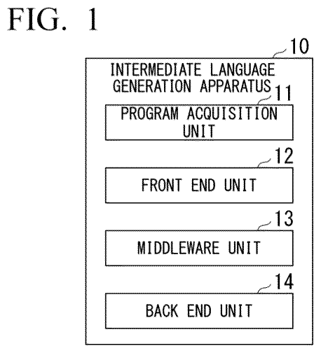

FIG. 1 is a diagram illustrating an example of an intermediate language generation apparatus 10 according to an example embodiment.

The intermediate language generation apparatus 10 is provided with a program acquisition unit 11, a front end unit 12, a middleware unit 13, and a back end unit 14.

The program acquisition unit 11 acquires a program (user program) to be executed.

The front end unit 12 generates intermediate language for the user program acquired by the program acquisition unit 11. As explained below, the front end unit 12, while generating the intermediate language from the user program, performs optimization as required to generate intermediate language for the entire user program.

The middleware unit 13 optimizes the intermediate language of the entire user program generated by the front end unit 12.

The back end unit 14 executes the intermediate language optimized by the middleware unit 13.

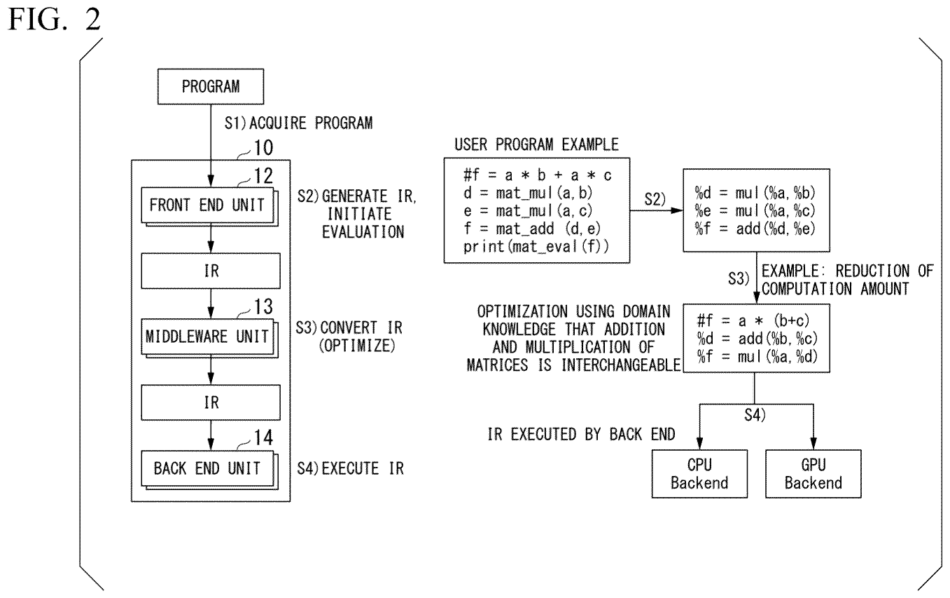

FIG. 2 schematically illustrates an intermediate language generation process and execution process performed by the intermediate language generation apparatus 10. (S1) The program acquisition unit 11 acquires a program (for example, User Program 0 below), and transfers the program to the front end unit 12.

(User program 0)

d = mat_mul(a, b)
e = mat_mul(a, c)
f = mat_add(d, e)
print(mat_eval(f))

In this case, mat_mul, mat_add, and mat_eva are functions included in a library using intermediate language. The function mat_mul is a library function for generating intermediate language for multiplying the arguments. The function mat_mul(a, b) generates intermediate language for executing the operation a×b (just the intermediate language is generated, and the operation a×b is not executed). The function mat_add is a library function for generating intermediate language for adding the arguments. The function mat_add(d, e) generates intermediate language for executing the operation d+e (just the intermediate language is generated, and the operation d+e is not executed). The function mat_eval is for instructing the execution of the generated intermediate language. When the function mat_eval(f) is called, the intermediate language for performing the operation f is executed (delayed execution). At this time, the operation d+e is executed. Additionally, the intermediate language for calculating d and e required for the operation f is also executed, and the operations a×b and a×c are executed.
(S2) The front end unit 12 generates intermediate language. The front end unit 12 outputs the generated intermediate language to the middleware unit 13.

### (Example of Generated Intermediate Language of User Program 0)

%d = mul(%a, %b)
%e = mul(%a, %c)
%f = add(%d, %e)

(S3) The middleware unit 13 optimizes the intermediate language. In the case of this example, the operation a×b+a×c can also be written a×(b+c), and since a×(b+c) involves fewer computations, the middleware unit 13 optimizes the intermediate language, for example, as indicated below. The middleware unit 13 outputs the optimized intermediate language to the back end unit 14.

### (Example of Optimized Intermediate Language)

%d = add(%b, %c)
%f = mul(%a, %d)

(S4) The back end unit 14 executes the intermediate language. The back end unit 14 executes the operation mat_eval(f). At this time, the intermediate language generated up to the previous step is executed (delayed execution). Since the intermediate language is abstract, the user program can be executed on various platforms such as CPUs, GPUs, etc. without changing the user program.

Next, the configuration of a front end unit 12 that enables intermediate language to be generated for an entire series of processes, even in the case in which execution results for a portion of intermediate language (whether or not there are multiple columns with the same name) affect the generation of the intermediate language for subsequent processes, as in the aforementioned example of reading data from a column in a table, will be explained.

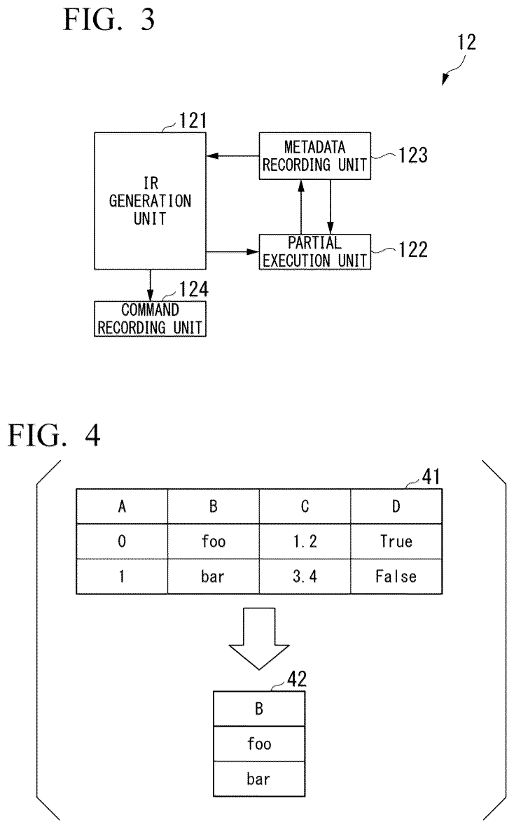

FIG. 3 is a diagram illustrating an example of the configuration of the front end unit 12.

The front end unit 12 is provided with an IR generation unit 121, a partial execution unit 122, a metadata recording unit 123, and a command recording unit 124.

The IR generation unit 121 generates intermediate language. The IR generation unit 121 does not simply convert the user program acquired by the program acquisition unit 11 to intermediate language, but cooperates with the partial execution unit 122 and the metadata recording unit 123 to use execution results of a portion of the intermediate language to generate intermediate language for subsequent processes. More specifically, in order to generate intermediate language for the entire series of processes, it has a function for assessing whether or not the execution of a portion of the intermediate language is required, and if it is required, a function for assessing the conditions in which the intermediate language is to be executed, a function for generating intermediate language for a portion required for subsequent processes, a function for instructing the partial execution unit 122 to execute the intermediate language for the portion, a function for generating intermediate language for the subsequent processes by using execution results from the partial execution unit 122, etc.

The partial execution unit 122 executes the intermediate language for the portion generated by the IR generation unit 121, and records the results thereof in the metadata recording unit 123. The execution results for the intermediate language for the portion will be referred to as metadata.

The metadata recording unit 123 records the execution results (metadata) of the intermediate language executed by the partial execution unit 122.

The command recording unit 124 stores the intermediate language generated by the IR generation unit 121 using the metadata. The intermediate language stored by the command recording unit 124 is transferred to the middleware unit 13.

Next, an example in which the front end unit 12 provided with the configuration indicated in FIG. 3 uses metadata to generate intermediate language will be explained.

### Example 1

As Example 1, User Program 1 will again be considered. Additionally, an example of a table included in data.csv, which is to be read, is shown in FIG. 4.

(User Program 1)

tbl = read_csv(“data.csv”)
sorted = sort_table(tbl, key=“A”)
result = project(tbl, “B”)

The IR generation unit 121 reads User Program 1 and assesses that it is required to know whether or not there are multiple columns named column B in the table tbl in order to generate the intermediate language of project(tbl, “B”). The IR generation unit 121 extracts the processes required for this assessment and generates intermediate language for the extracted processes (intermediate language of a portion). Additionally, it is analyzed that only the first line (the line with the column name) of the data requires to be read from the generated intermediate language for the portion. The IR generation unit 121 transfers the generated intermediate language for the portion to the partial execution unit 122 and issues an instruction to execute the intermediate language.

### (Example of Intermediate Language for the Portion)

%1 = read_csv(“data.csv”)
%2 = sort_table(%1, “A”)

The partial execution unit 122 executes the above-mentioned intermediate language. The partial execution unit 122 reads only the column names (the first line) by means of read_csv, and sorts the read column names by means of sort_table. As a result thereof, processes for reading the column names in table 41 in FIG. 4 and for sorting by column A are executed. The execution results (metadata) are indicated below.
Column names in %1: [“A”, “B”, “C”, “D” ]#read only first line
Column names in %2: [“A”, “B”, “C”, “D” ]#same as inputs to sort_table

The metadata recording unit 123 stores the metadata of the execution results. The metadata in the case of this example includes the column names A-D in the table.

The IR generation unit 121 acquires the metadata from the metadata recording unit 123 and generates intermediate language for subsequent processes. As a result of the partial execution, it was found that there are no redundant column names. Thus, the IR generation unit 121 can select the project_column command regarding project(tbl, “B”). An example of the generated intermediate language is shown below. The execution results of this intermediate language are indicated in table 42 of FIG. 4.

### (Example of Intermediate Language)

%1 = read_csv(“data.csv”)
%2 = sort_table(%1, “A”)
%3 = project_column(%2,”B”)

### Example 2

As Example 2, User Program 2 below will be considered.

(User Program 2)

tbl = read_csv(“data.csv”)
sorted = sort_table(tbl, key=“A”)
result = tbl.B

The function tbl.B means that, when the column name is B, column B is extracted, and when the column name is not B, the attribute B of the tbl object is extracted. Additionally, as intermediate language, suppose that there are a project_column command for extracting column B and a getattr command for extracting attributes. Since the IR generation unit 121 does not know whether or not there is a column B in a table, the entire User Program 3 cannot be directly converted to intermediate language. Therefore, the IR generation unit 121 instructs the partial execution unit 122 to execute a portion. Assuming that the table to be processed is the same as the table 41 indicated in FIG. 4, the intermediate language for the portion to be executed and the execution results thereof are the same as those explained in Example 1. The metadata in the case of this example includes the column names in the table. The IR generation unit 121 recognizes, from the metadata (column names) obtained by executing the intermediate language for the portion, that there is a column B in the table, selects a project_column command regarding the library function tbl.B, and generates intermediate language for the entire User Program 3. The generated intermediate language is the same as that in Example 1.

### Example 3

As Example 3, User Program 3 below will be considered.

(User Program 3)

tbl = read_csv(“data.csv”)
sorted = sort_table(tbl, key=“A”)
tmp = unique(tbl, key=“A”)
result = tmp[“B”]

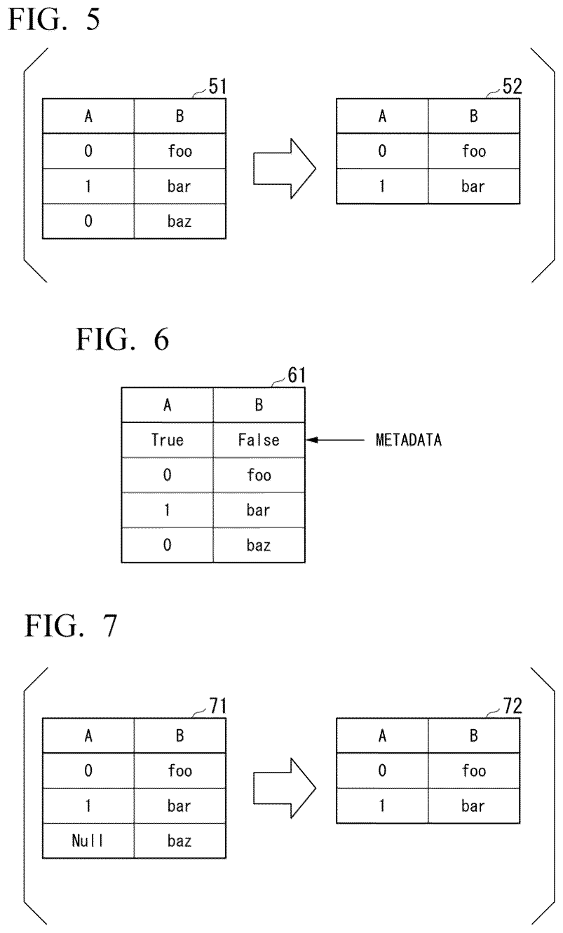

The function unique is for deleting rows with redundant data from a column designated by an argument. Additionally, the function tmp[“B” ] is a function for returning the data in column B. Supposing that the table 51 indicated in FIG. 5 is the table to be processed, since there are two rows in which the data for column A is 0, when unique(tbl, key=“A”) is executed, the latter row is deleted and table 52 is obtained. For example, if there are no rows with redundant data in column A, there is no need to execute unique(tbl, key=“A”). In this case, the amount of computation can be reduced (optimized) by generating intermediate language in which unique(tbl, key=“A”) is not executed. In order to check whether or not there are redundant rows in column A, the IR generation unit 121 generates intermediate language for a portion and instructs the partial execution unit 122 to execute the generated intermediate language.

### (Example of Intermediate Language for Portion)

%1 = read_csv(“data.csv”)
%2 = sort table(%1, “A”)

The partial execution unit 122 executes the above-mentioned intermediate language. The table 51 in FIG. 5 is read and, for example, a uniqueness test is performed regarding whether or not there are redundant rows in the respective columns. The results of the uniqueness test are metadata. In the case of the table 51 in FIG. 5, column A has redundant rows and column B does not have redundant rows. Therefore, the results of the uniqueness test are that column A has redundant rows (True) and that column B does not have redundant rows (False). The results of the uniqueness test are indicated in the table 61 in FIG. 6. The table 61 is recorded in the metadata recording unit 123. The IR generation unit 121, from the results thereof, executes tmp=unique(tbl, key=“A”) and generates intermediate language for the entire User Program 4.

### Example 4

As Example 4, User Program 4 below will be considered.

(User Program 4)

tbl = read_csv(“data.csv”)
sorted = sort_table(tbl, key=“A”)
tmp = dropna(tbl, key=“A”)
result = tmp[“B”]

The function dropna is for deleting data with invalid values (Null) from a column designated by an argument. Supposing that the table 71 indicated in FIG. 7 is the table to be processed, since there is a Null row in column A, when dropna(tbl, key=“A”) is executed, the Null row is deleted and the table 72 is obtained. Since the IR generation unit 121 does not know whether or not there are invalid values in column A in the table, the partial execution unit 122 is instructed to execute the intermediate language for a portion. The partial execution unit 122 executes the intermediate language for the portion. The partial execution unit 122 reads all of the data for read_csv, and calculates the number of invalid values in each column. The number of invalid values is metadata. The partial execution unit 122 executes sort_table. Since the number of invalid values does not change with sort_table, the number of invalid values in the results of sort_table is made the same. The IR generation unit 121 references the metadata (number of invalid values in each column), generates intermediate language with a dropna command when column A has an invalid value, and if not, generates intermediate language without a dropna command.

### Example 5

As Example 5, User Program 5 below will be considered.

(User Program 5)

tbl1 = read_csv(“data1.csv”)
tbl2 = read csv(“data2.csv”)
tbl = join(% tb10, % tbl1, “A”)
result = project(tbl,”B”)

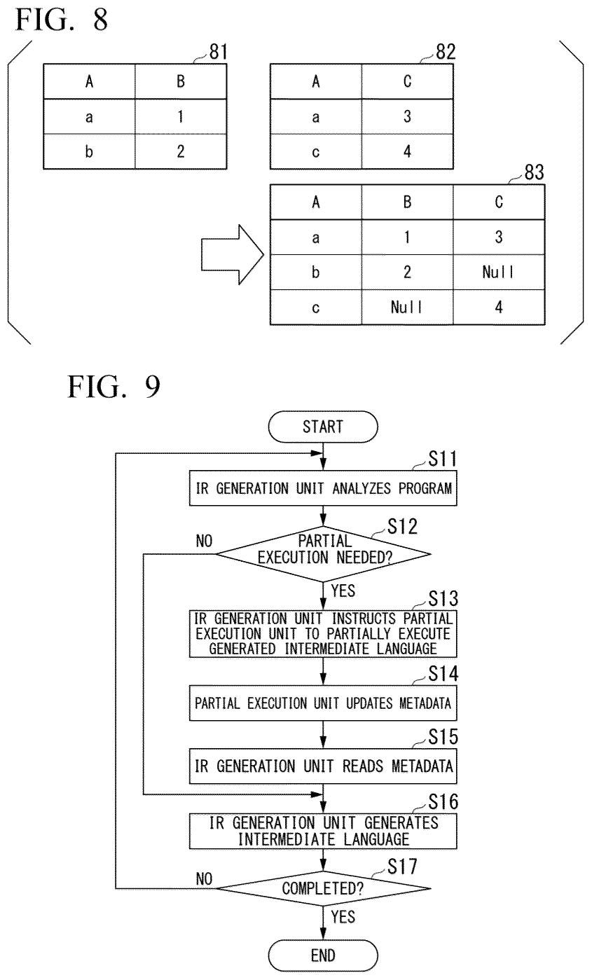

The function join is for joining tables by using a column designated by an argument as a key. Supposing that the tables 81, 82 indicated in FIG. 8 are the tables to be processed, the table after the join becomes the table 83.

Since the IR generation unit 121 does not know whether or not there are multiple columns named column B in the table after the join, the partial execution unit 122 is instructed to execute the intermediate language for a portion. The partial execution unit 122 executes the intermediate language for the portion. The partial execution unit 122 reads the first rows (column names) in data1.csv and data2.csv, and joins the column names by using column A as a key. In this example, the column names are metadata. The IR generation unit 121 references the metadata (column names), and since there are not multiple columns named column B, selects the project_column command for the library function project(tbl, “B”), and generates intermediate language for the entire User Program 5.

In the user programs described above, examples were explained in which intermediate language for subsequent processes was generated in accordance with metadata, where the metadata were the results of reading data from a table. However, reading from a table is not essential. For example, the intermediate language generation method of the present example embodiment can be applied even in the case in which a user program is configured to branch between whether to execute process B or to execute process C in accordance with results from process A. In the case of this example, the IR generation unit 121 generates intermediate language for process A, and the partial execution unit 122 executes this intermediate language. The IR generation unit 121 generates intermediate language for process B or for process C in accordance with the processing results of the intermediate language of process A.

### (Operations)

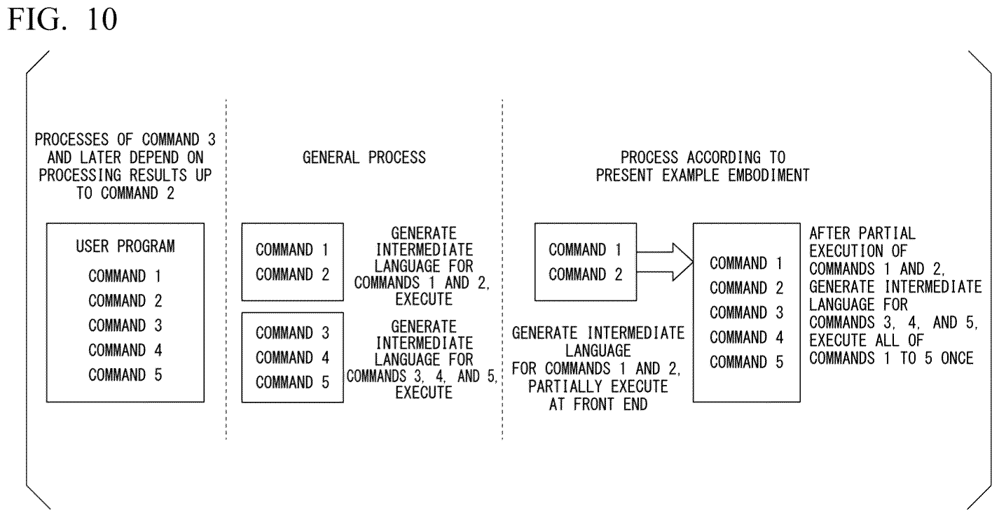

Next, the flow of the intermediate language generation process will be explained with reference to FIG. 9.

FIG. 9 is a flow chart indicating an example of the intermediate language generation process according to an example embodiment.

The IR generation unit 121 analyzes a program to be executed (step S11). The IR generation unit 121 analyzes whether, unless intermediate language is executed for a portion of a series of processes written in a program to be executed, the intermediate language cannot be generated for processes subsequent thereto or efficient intermediate language cannot be generated. If partial execution of a portion of the processes is required, the IR generation unit 121 generates intermediate language for the portion of the processes and calculates execution conditions (e.g., reading only the first line (column names), etc.) regarding the generated intermediate language as required.

As a result of the analysis, if there is no need for partial execution (step S12: No), the process proceeds to step S16. If there is a require for partial execution (step S12: Yes), the IR generation unit 121 outputs the generated intermediate language and the execution conditions to the partial execution unit 122 and instructs the partial execution unit 122 to partially execute the generated intermediate language (step S13). The partial execution unit 122 executes the intermediate language for the portion acquired from the IR generation unit 121 under the execution conditions acquired from the IR generation unit 121. The partial execution unit 122 records the execution results as metadata in the metadata recording unit 123, and updates the metadata (step S14). Next, the IR generation unit 121 reads the metadata from the metadata recording unit 123 (step S15). The IR generation unit 121 generates the intermediate language for subsequent processes in accordance with the metadata that has been read (step S16). The IR generation unit 121 assesses whether or not the conversion of the program to be executed to intermediate language has been completed (step S17). If intermediate language has been generated for all of the processes written in the program to be executed, the conversion is assessed to have been completed, and if not, the conversion is assessed to have not been completed.

If it is assessed that the conversion has been completed (step S17: Yes), the IR generation unit 121 adds the intermediate language for the subsequent processes to the intermediate language for the portion that has already been generated, thereby generating intermediate language for the entire program to be executed, and records the generated intermediate language in the command recording unit 124. The front end unit 12 outputs the intermediate language that has been recorded in the command recording unit 124 to the middleware unit 13 and ends the process in FIG. 9. The intermediate language is optimized by the middleware unit 13, then is executed by the back end unit 14 when mat_eval is executed. If it is assessed that the conversion has not been completed (step S17: No), the process returns to step S11, and the process from step S11 is repeatedly executed regarding the processes for which intermediate language has not been generated.

### (Effects)

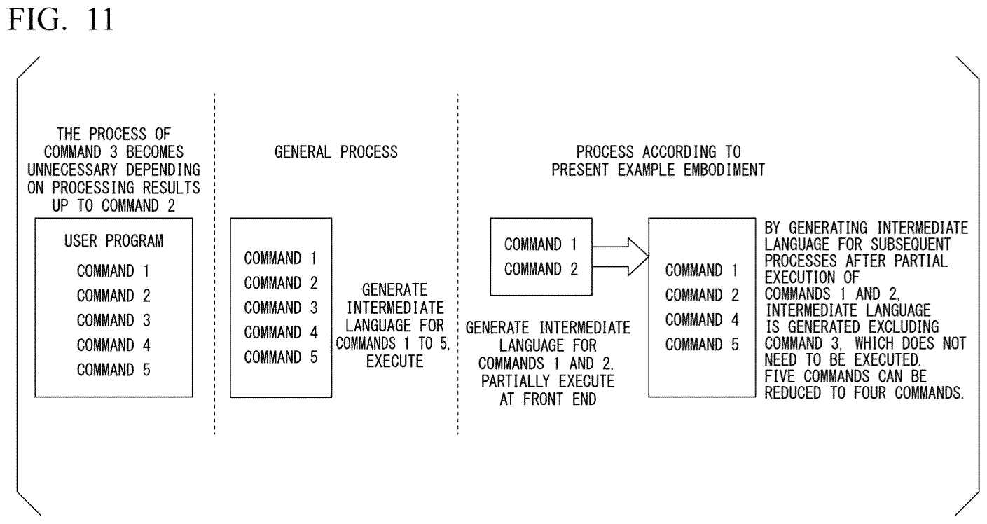

As explained above, according to the present example embodiment, intermediate language is executed for a portion of a series of processes written in a program to be executed, and based on metadata that is the result thereof, intermediate language is also generated for subsequent processes. As a result thereof, more efficient intermediate language can be generated in comparison with a common processing scheme in which a front end unit 12 executes intermediate language generated by a back end unit 14 during the generation of intermediate language for a series of processes, the front end unit 12 generates the intermediate language for the remaining processes, and the back end unit 14 executes the intermediate language. For example, as illustrated in FIG. 10, in the present example embodiment, intermediate language for the entire series of processes can be generated by executing a partial process, and the back end unit 14 can finally execute the intermediate language for the entire series of processes. Thus, the middleware unit 13 can perform optimization for the entire process. Additionally, as illustrated in FIG. 11, according to the present example embodiment, by executing a partial process, unneeded processes can be omitted to generate intermediate language (e.g., unique(tbl, key=“A”) in Example 3), and the amount of processing can be reduced.

### Other Example Embodiments

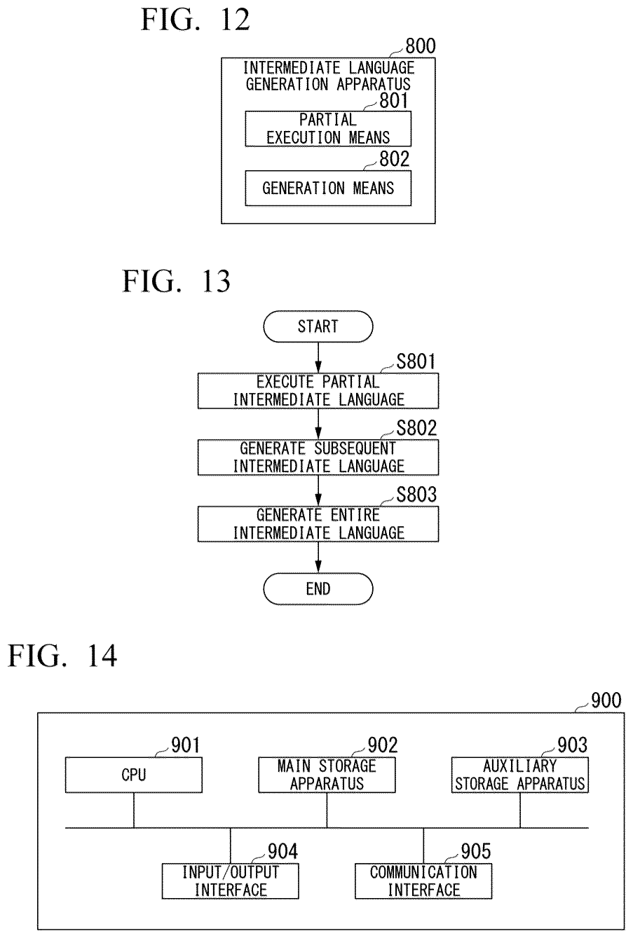

FIG. 12 is a diagram illustrating another example of an intermediate language generation apparatus according to an example embodiment.

An intermediate language generation apparatus 800 is provided with a portion execution means 801 and a generation means 802. The portion execution means 801, when generating intermediate language for processes written in a program to be executed, generates intermediate language for a portion of the processes and executes the generated intermediate language for the aforementioned portion.

The generation means 802, based on the execution results of the intermediate language for the portion, generates intermediate language regarding processes, among the aforementioned processes, subsequent to the portion of the processes. Additionally, the generation means 802 adds the intermediate language for the subsequent processes after the intermediate language for the portion, thereby generating intermediate language corresponding to the entire program to be executed. The intermediate language corresponding to the entire program refers not to the generation of intermediate language for all commands written in a program, but to the generation of intermediate language for all of the commands that require to be executed after assessing whether or not all of the commands written in the program require to be executed.

The IR generation unit 121 and the partial execution unit 122 are an example of the portion execution means 801.

The IR generation unit 121 is an example of the generation means 802.

FIG. 13 is a flow chart indicating an example of the operations of an intermediate language generation apparatus according to an example embodiment.

The portion execution means 801, when generating intermediate language for processes written in a program to be executed, generates intermediate language for a portion of the processes and executes the generated intermediate language for the portion (step S801). Next, the generation means 802, based on the execution results of the intermediate language for the portion, generates intermediate language regarding processes, among the aforementioned processes, subsequent to the portion of the processes (step S802). Next, the generation means 802 adds the intermediate language for the subsequent processes after the intermediate language for the portion, thereby generating intermediate language corresponding to the entire program to be executed (step S803).

FIG. 14 is a diagram illustrating an example of the hardware configuration of an intermediate language generation apparatus according to an example embodiment.

A computer 900 is provided with a CPU 901, a main storage apparatus 902, an auxiliary storage apparatus 903, an input/output interface 904, and a communication interface 905. The intermediate language generation apparatuses 10, 800 mentioned above are implemented in the computer 900. Furthermore, the respective functions mentioned above are stored in the auxiliary storage apparatus 903 in the form of a program. The CPU 901 reads the program from the auxiliary storage apparatus 903, loads the program in the main storage apparatus 902, and executes the processes described above in accordance with the program. Additionally, the CPU 901 secures storage areas in the main storage apparatus 902 in accordance with the program. Additionally, the CPU 901 secures, in the auxiliary storage apparatus 903, storage areas for storing data being processed in accordance with the program.

A program for realizing some or all of the functions of the intermediate language generation apparatuses 10, 800 may be recorded in a computer-readable recording medium, and the program recorded in this recording medium may be read into a computer system and executed to perform the processes according to the respective functional units. Additionally, in this case, a “computer system” refers to a system including an OS and hardware such as peripheral devices. Additionally, a “computer system” may include a homepage-providing environment (or display environment) in the case in which a web-based system is used. Additionally, a “computer-readable recording medium” refers to portable media such as CDs, DVDs, USBs, etc., and to storage apparatuses, such as hard disks, that are internal to a computer system. Additionally, in the case in which this program is distributed to a computer 900 by means of communication lines, the computer 900 to which the program has been distributed may load the program in a main storage apparatus 902 to execute the processes described above. Additionally, the program described above may be for realizing just some of the aforementioned functions, and furthermore, may realize the aforementioned functions in combination with a program already recorded in a computer system.

As described above, a method for generating intermediate language for computer program code is disclosed. According to the present disclosure, for example, intermediate language can be executed for a portion of a series of processes, and based on the results thereof, intermediate language can also be generated for subsequent processes.

While an example embodiment of the present disclosure has been explained in detail with reference to the drawings, the specific configurations are not limited to those mentioned above, and various design modifications, etc. are possible within a range not departing from the gist of this disclosure. Additionally, an example embodiment of the present disclosure can be variously modified within the range indicated in the claims, and embodiments obtained by appropriately combining the technical means disclosed respectively in different example embodiments are also included within the technical scope of the present disclosure. Additionally, configurations in which the elements mentioned in the example embodiments and modified examples described above and providing similar effects are replaced with each other are also included. Furthermore, the respective example embodiments can be combined, as appropriate, with other example embodiments.

Some or all of the example embodiments described above may be described as in the appendices below. However, the possible example embodiments are not limited to those indicated below.

### APPENDIX 1

An intermediate language generation apparatus comprising: means for executing an intermediate language for a portion of processes written in a program to be executed, wherein the means for executing an intermediate language for the portion, in generating an intermediate language for the processes written in the program to be executed, generates the intermediate language for the portion of the processes and executes the generated intermediate language for the portion; and means for generating an intermediate language corresponding to the entire program, wherein the means for generating, based on execution results of the intermediate language for the portion, generates an intermediate language for processes subsequent to the portion of processes among the processes, and generates the intermediate language corresponding to the entire program, in which the intermediate language for the subsequent processes is added to the intermediate language for the portion.

### APPENDIX 2

The intermediate language generation apparatus according to appendix (1), wherein the means for generating determines a command in the subsequent processes based on the execution results of the intermediate language for the portion, and generates the intermediate language for the command that has been determined.

### APPENDIX 3

The intermediate language generation apparatus according to either appendix (1) or (2), wherein the means for generating assesses, based on the execution results of the intermediate language for the portion, whether or not a command included in the subsequent processes requires to be executed, and generates, in a case where the command does not require to be executed, the intermediate language for the subsequent processes excluding the command.

### APPENDIX 4

The intermediate language generation apparatus according to any one of appendices (1) to (3), wherein the means for executing the intermediate language for the portion executes the intermediate language for the portion to calculate a column name of data in table form.

### APPENDIX 5

The intermediate language generation apparatus according to any one of appendices (1) to (4), wherein the means for executing the intermediate language for the portion executes the intermediate language for the portion to calculate whether or not there is a redundant column name among column names in data in table form.

### APPENDIX 6

The intermediate language generation apparatus according to any one of appendices (1) to (5), wherein the means for executing the intermediate language for the portion executes the intermediate language for the portion to calculate whether or not there is an invalid value for a column name in data in table form.

### APPENDIX 7

The intermediate language generation apparatus according to any one of appendices (1) to (5), wherein the means for executing the intermediate language for the portion executes the intermediate language for the portion to calculate whether or not there is a designated column name among column names in data in table form.

### APPENDIX 8

The intermediate language generation apparatus according to any one of appendices (1) to (7), wherein the means for executing the intermediate language for the portion executes the intermediate language for the portion to calculate whether or not there is a redundant column name among column names in data in table form; and the means for generating, in a case where a column name in the data in the table form is redundant, generates an intermediate language for a command to acquire all data with a designated column name, even if the column name is redundant, as the intermediate language for the subsequent processes, and generate, in a case where there are no redundant column names in the data in the table form, an intermediate language for a command to acquire data with a designated column name as the intermediate language for the subsequent processes.

### APPENDIX 9

An intermediate language generation method comprising steps of, in generating an intermediate language for processes written in a program to be executed, generating an intermediate language for a portion of the processes, and executing the generated intermediate language for the portion; and generating, based on execution results of the intermediate language for the portion, an intermediate language for processes subsequent to the portion of processes among the processes, and generating an intermediate language corresponding to the entire program, in which the intermediate language for the subsequent processes is added to the intermediate language for the portion.

### APPENDIX 10

A program for making a computer execute steps of, in generating an intermediate language for processes written in a program to be executed, generating an intermediate language for a portion of the processes, and executing the generated intermediate language for the portion; and generating, based on execution results of the intermediate language for the portion, an intermediate language for processes subsequent to the portion of processes among the processes, and generating an intermediate language corresponding to the entire program, in which the intermediate language for the subsequent processes is added to the intermediate language for the portion.

While preferred example embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

What is claimed is:

1. An intermediate language generation apparatus comprising:
at least one memory configured to store instructions; and
at least one processor configured to execute the instructions to:
in generating an intermediate language for processes written in the program to be executed, generate an intermediate language for a portion of the processes and execute the generated intermediate language for the portion; and
generate, based on execution results of the intermediate language for the portion, an intermediate language for processes subsequent to the portion of processes among the processes, and generate an intermediate language corresponding to the entire program, in which the intermediate language for the subsequent processes is added to the intermediate language for the portion.

2. The intermediate language generation apparatus according to claim 1,
wherein the at least one processor is configured to execute the instructions to determine a command in the subsequent processes based on the execution results of the intermediate language for the portion, and generate the intermediate language for the determined command.

3. The intermediate language generation apparatus according to claim 1,
wherein the at least one processor is configured to execute the instructions to assess, based on the execution results of the intermediate language for the portion, whether or not a command included in the subsequent processes requires to be executed, and generate, in a case where the command does not require to be executed, the intermediate language for the subsequent processes excluding the command.

4. The intermediate language generation apparatus according to claim 1,
wherein the at least one processor is configured to execute the instructions to execute, in executing the generated intermediate language for the portion, the intermediate language to calculate a column name of data in table form.

5. The intermediate language generation apparatus according to claim 1,
wherein the at least one processor is configured to execute the instructions to execute, in executing the generated intermediate language for the portion, the intermediate language to calculate whether or not there is a redundant column name among column names in data in table form.

6. The intermediate language generation apparatus according to claim 1,
wherein the at least one processor is configured to execute the instructions to execute, in executing the generated intermediate language for the portion, the intermediate language to calculate whether or not there is an invalid value for a column name in data in table form.

7. The intermediate language generation apparatus according to claim 1,
wherein the at least one processor is configured to execute the instructions to execute, in executing the generated intermediate language for the portion, the intermediate language to calculate whether or not there is a designated column name among column names in data in table form.

8. The intermediate language generation apparatus according to claim 1,
wherein the at least one processor is configured to execute the instructions to:
execute, in executing the generated intermediate language for the portion, the intermediate language for the portion to calculate whether or not there is a redundant column name among column names in data in table form; and
generate, in a case where a column name in the data in the table form is redundant, an intermediate language for a command to acquire all data with a designated column name, even if the column name is redundant, as the intermediate language for the subsequent processes, and generate, in a case where there are no redundant column names in the data in the table form, an intermediate language for a command to acquire data with a designated column name as the intermediate language for the subsequent processes.

9. An intermediate language generation method comprising:
in generating an intermediate language for processes written in a program to be executed, generating an intermediate language for a portion of the processes, and executing the generated intermediate language for the portion; and
generating, based on execution results of the intermediate language for the portion, an intermediate language for processes subsequent to the portion of processes among the processes, and generating an intermediate language corresponding to the entire program, in which the intermediate language for the subsequent processes is added to the intermediate language for the portion.

10. A non-transitory storage medium that stores a program for causing a computer to execute processes, the processes comprising:
in generating an intermediate language for processes written in a program to be executed, generating an intermediate language for a portion of the processes, and executing the generated intermediate language for the portion; and
generating, based on execution results of the intermediate language for the portion, an intermediate language for processes subsequent to the portion of processes among the processes, and generating an intermediate language corresponding to the entire program, in which the intermediate language for the subsequent processes is added to the intermediate language for the portion.
